(19) United States
(12) Patent Application Publication
(10) Pub. No.: US 2008/0096495 A1
(43) Pub. Date: Apr. 24, 2008

(54) Collaborated Physiological Data Testing Instrument Module in Mobile Communication Device

(76) Inventor: Ein-Yiao Shen, Taipei (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/552,499

(22) Filed: Oct. 24, 2006

(51) Int. Cl. H04B 17/00

(52) U.S. Cl. 455/100; 455/67.11

(57) ABSTRACT

The human physiological data testing instrument module is minimized and digitalized and then collaborated in the mobile communication device in the way of external connection, internally built-in, or insertion so as to treat the acquired data to display on, store in, or deliver an alarm signal from the mobile communication device, or transmit to a distant medical station for the doctor there to check the health condition of the client, or give a medical attention if necessary.

### BACKGROUND OF THE INVENTION

1. Field of the invention

The present invention relates to a collaborated physiological data testing instrument module in a mobile communication device, and more particularly, to a miniaturized and digitalized human body physiological data testing instrument module collaborated in a mobile communication device in the manner of external connection, internally built-in, or insertion.

2. Description of the Prior Art

The astonishing progress in science has promoted the development of various mobile communication devices, which originally have singular function, to have several functions such as capable of connecting to a web site, operable as a digital camera, and video player. In view of the present situation that mobile phones become so popular in use, there is a powerful potential in extending its field of application. There are several on-body measuring instruments applicable for measuring body temperature, blood pressure, pulse rate, blood sugar level, and blood biochemical data, etc. There are also a lot of already matured portable physiological data sensing and monitoring means waiting for further expansion in their field of application. Should it be possible to treat data obtained by the aforesaid instruments and sensing means collaborated in a mobile communication device and allowing the data to be displayed on, stored in, or deliver alarm from this device, or transmit such data to a distant receiver or message center, it would contribute greatly to human welfare.

Due to rapid progress in the bio-chip and the human body physiological data measurement technology, various human physiological data can be detected and monitored from bio-chips either by on-body, or by under skin implantation so as to detect and collect information regarding symptoms of illness thereby notifying the patient. Due to marvelous progress in above-said biochemical technology along with the development of the microelectronic device and nanometer science, it is becoming easier to detect the human physiological condition through on-body, under skin, or even in gastrointestinal tract bio-chips.

It is therefore a great urgent matter to develop mobile communication devices, popular in use, and compatible with the human physiological condition measuring means for acquiring the various necessary data from time to time to improve medical care and illness prevention.

For carrying out the above idea, the applicant has previously acquired and/or applied/received the following patents, all of which are herein incorporated by reference in their entirety: “Cellular phone combined physiological condition examination and processing device” (U.S. Pat. No. 7,031,745), “Mobile phone combined physiological function detector” (U. S. Pat. No. 6,428,475), “Physiological sensing means Collaborated With Mobile Phone” (Taiwan Pat. No.0,045,402), “Transmission Interface of PDA Connected With Physiological Symbol Detector” (Taiwan Pat. No.00,462,000), “Human Body Physiological Signal Processing Unit in Connection with Mobile Phone” (Taiwan Pat. No. 200,412,777), “Earphone Type Physiological Data Sensor” (Taiwan Pat. No.M241002), “Life signal Wireless Transmission 1” (Taiwan Pat. No.1,249,122), and “Mobile Communication Device with Ear Temperature Sensor” (Taiwan Pat. No.M292,221).

In view of the situation that there is ample room for improving the aforesaid related facilities for the sake of human welfare, the present invention has finally surfaced after long term research and experimentation carried out by the applicant.

### SUMMARY OF THE INVENTION

Accordingly, it is an object of the present invention to provide a collaborated physiological data testing instrument module in mobile communication device in which a miniaturized and digitalized human body physiological data testing instrument module can be collaborated in a mobile communication device in the manner of external connection, internally built-in, or as an insertion so as to treat the acquired data with the aforesaid module in the mobile communication device for displaying, storing, alarming or transmit to a distant medical station for making a precise diagnosis.

Another object of the present invention is to provide a human physiological data testing instrument module collaborated and/or incorporated in the mobile communication device to perform the stated mission of monitoring or data collecting by direct and/or indirect contact with the human body, by scanning, by under-skin implantation, or by other known invasive methods. The testing can be carried out in both physical and biochemical manner. The physical test includes skin color turgor, texture and moisture, physical ability, fat density, bone density, blood pressure, pulse rate, electrocardiogram, and respiratory function. The biochemical test includes known blood tests, for example, blood sugar, blood oxygen content and body biochemical analysis.

Still another object of the present invention is to offer an extra premium to mobile communication devices by collaborating and/or incorporating the the aforesaid testing function.

One more object of the present invention is to provide a collaborated physiological data testing instrument module in mobile communication system capable of carrying out monitoring and testing efficiently and conveniently, and can be constructed at relative low cost, and made compact and portable in size.

To achieve these and other objects mentioned above, the physiological data testing instrument module is miniaturized and digitalized and then collaborated and/or incorporated in the mobile communication device by external connection, internally built-in, or as an external insert or attachment so as to treat the acquired data to display on, store in, or deliver an alarm signal from the mobile communication device, or transmit to a distant medical station.

### BRIEF DESCRIPTION OF THE DRAWINGS

FIG. 1 is a block flow diagram showing the scheme of the present invention; and

FIG. 2 to FIG. 4 are respectively the schematic views showing first to third embodiments of the present invention.

### DETAILED DESCRIPTION OF THE PREFERRED EMBODIMENT

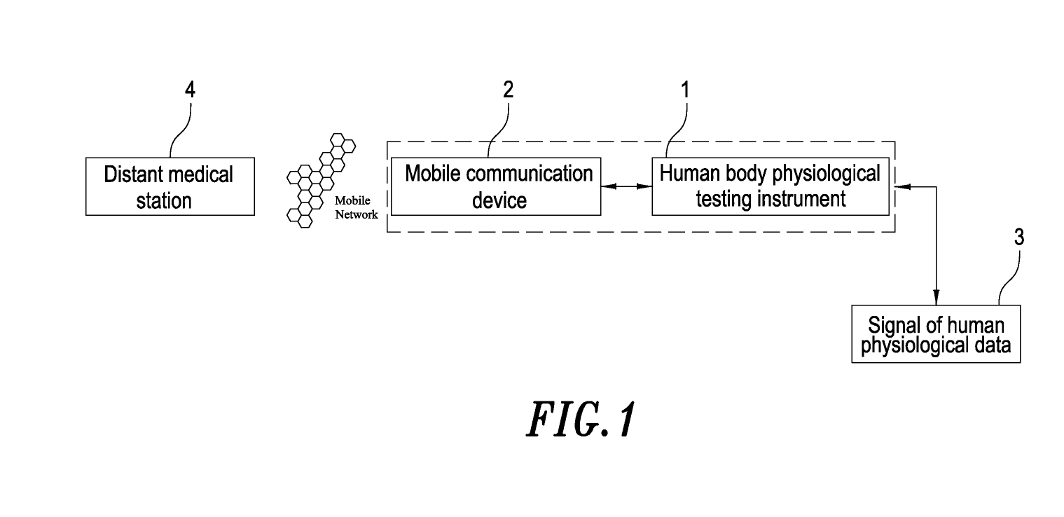

Referring to FIG. 1, the present invention is composed of a human body physiological data testing instrument module 1, and a mobile communication device 2.

The human body physiological data testing instrument module 1 (to be abbreviated as testing module 1 in the following description) is capable of monitoring or detecting human body physical signals 3 and transmitting those signals 3 to the mobile communication device 2. The tests, which can be preformed by the testing module 1 by means of direct or indirect contact with, scanning, or implanting into, the human body, include known physical and biochemical tests. Example of known physical test include skin color turgor, texture and moisture, physical ability, fat density, bone density, blood pressure, pulse rate, electrocardiogram, and respiratory function. Examples of biochemical test include blood test including blood sugar, blood oxygen content and body fluid test.

The mobile communication device 2 is capable of receiving data signals from the testing module 1 and displaying, storing the data, delivering alarm signal or transmitting the data to a distant medical station 4. The mobile communication device 2 includes a mobile phone, a personal digital assistant (PDA), and a miniature computer.

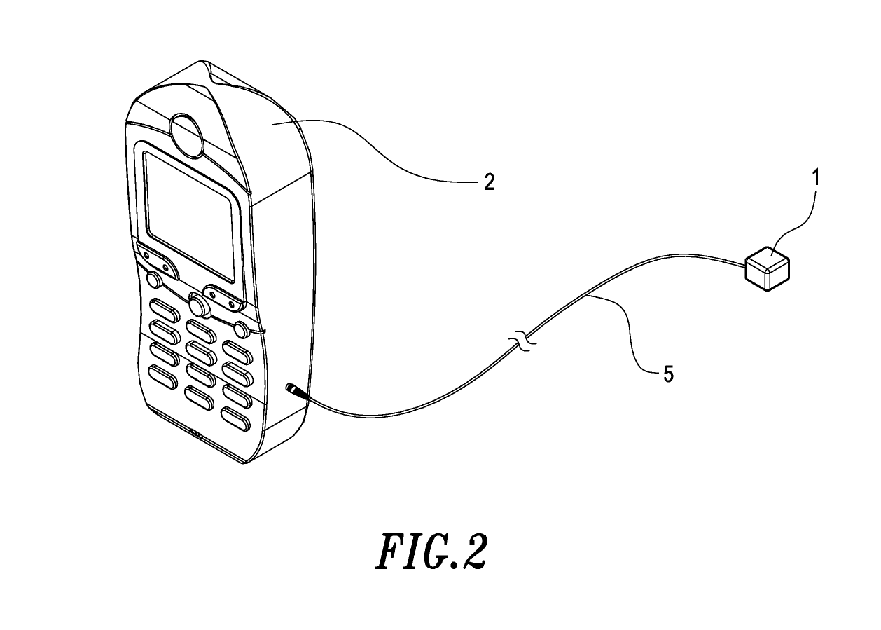

Referring to FIG. 2, in this first embodiment of the present invention, the testing module 1 is externally connected to the mobile communication device 2 with transmission wires 5 so as to monitor or detect the human physiological signals and display on, store in, or deliver an alarm signal from, the mobile communication device 2, or to transmit the above data to a distant medical station.

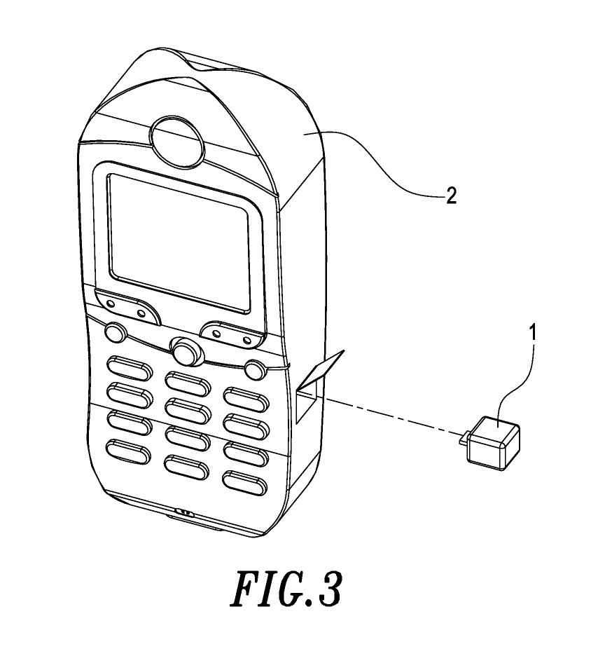

Referring to FIG. 3, in this second embodiment of the present invention, the testing module 1 is collaborated with the mobile communication device 2 by detachably inserting the former into the latter so as to monitor or detect the human physiological signals and display on, store in, or deliver an alarm signal from, the mobile communication device 2, or to transmit the above data to a distant medical station by the communication device 2.

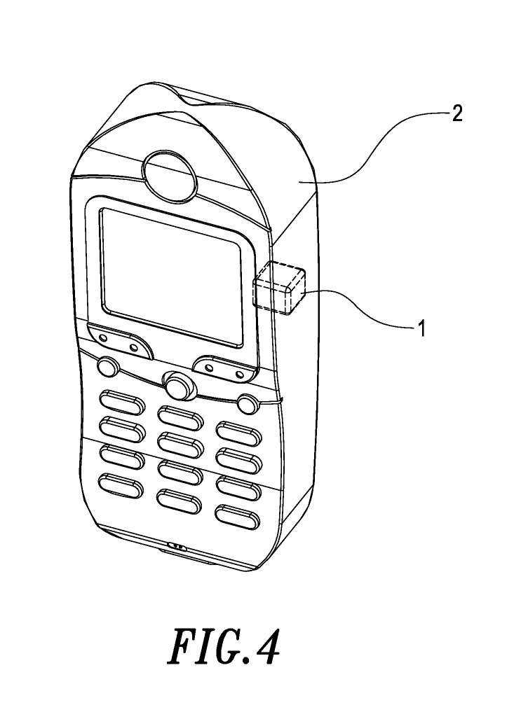

Referring to FIG. 4, in this third embodiment of the present invention, the testing module 1 is collaborated with the mobile communication device 2 in a built-in state so as to monitor or detect the human physiological signals and display on, store in, or deliver an alarm signal from, the mobile communication device 2, or to transmit the above data to a distant medical station.

In all, the merits of the present invention can be summarized as follows:

1. The testing module is collaborated with the mobile communication device, which is portable, to provide constant data collection and timely monitoring to a person anywhere and anytime. And if necessary, the testing module and/or the communication device can transmit information to a distant medical station to get immediate advice from a doctor.

2. A variety of physical and biochemical human physiological data can be acquired by direct or indirect contact with, or by scanning the user's body, or by implanting biochips under skin of the user's body.

3. The present invention can increase associated utilitarian value of a conventional mobile communication device, such that it can serve as a medial device.

4. The device of the present invention can be easily and conveniently operated and carried. It is produced at relative low cost, made compact, portable and dexterous.

5. The fabrication of the present invention may rely on the cooperation of medical instrument and the electronic product manufacturers, and make them both profiteers in widening their sales and market.

It is understood that the present invention is a high level technical creation and by no means, simply utilizes conventional technology or knowledge known prior to the application for patent, or can easily made by persons skilled in the arts prior to the application for patent. Thus the present invention is submitted for applying patent.

Those who are skilled in the art will readily perceive how to modify the invention. Therefore the appended claims are to be construed to cover all equivalent structures which fall within the true scope and spirit of the invention.

What is claimed is:

1. A collaborated physiological data testing instrument module in mobile communication device, wherein it utilizes a digitalized miniature module connected to said mobile communication device so as to monitor and acquire said physiological data and display on, store in, or deliver an alarm signal from said mobile communication device, or transmit said data to a distant medical station.

2. The testing module of claim 1, wherein said testing is carried out in both physical and biochemical manner, items of said physical test includes skin color turgor, texture and moisture, physical ability, fat density, bony density, blood pressure pulse rate, electrocardiogram, and respiratory function, while items of said biochemical tests.

3. The testing module of claim 1, wherein said testing module is operable in the manner of direct of indirect contact with the human body, scanning the body or implanting a biochip under skin.

4. The testing module of claim 1, wherein said mobile communication device is a mobile phone, a personal digital assistant and a miniature computer.

5. The testing module of claim 1, wherein said testing module is connected to said mobile communication device with transmission wires.

6. A collaborated physiological data testing instrument module in mobile communication device, wherein it utilizes a digitalized miniature module externally inserted into said mobile communication device so as to monitor and acquire said physiological data and display on, store in or deliver an alarm signal from said mobile communication device, or transmit said data to a distant medical station.

7. The testing module of claim 6, wherein said testing is carried out in both physical and biochemical manner, items of said physical test includes skin color turgor, texture and moisture, physical ability, fat density, bony density, blood pressure, pulse rate, electrocardiogram, and respiratory function, while items of said biochemical test includes blood test including blood sugar, blood oxygen content and body fluid analysis.

8. The testing module of claim 6, wherein said testing module is oparable in the manner of direct or indirect contact with the human body, scanning the body, or implanting a biochip under skin.

9. The testing module of claim 6, wherein said mobile communication device is a mobile phone, a personal digital assistant, and a miniature computer.

10. A collaborated physiological data testing instrument module in mobile communication device, wherein it utilizes a digitalized miniature module internally built in said mobile communication device so as to monitor and acquire said physiological data and display on, store in, or deliver an alarm signal from said mobile communication device, or transmit said data to a distant medical station.

11. The testing module of claim 10, wherein said testing is carried out in both physical and biochemical manner, items of said physical test includes skin color turgor, texture and moisture, physical ability, fat density, bony density, blood pressure, pulse rate, electrocardiogram, and respiratory function, while items of said biochemical test includes blood test including blood sugar, blood oxygen content and body fluid analysis.

12. The testing module of claim 10, wherein said testing module is operable in the manner of direct of indirect contact with the human body, scanning the body, or implanting a biochip under skin.

13. The testing module of claim 10, wherein said mobile communication device is a mobile phone, a personal digital assistant, and a miniature computer.
